(19) United States
(12) Patent Application Publication
(10) Pub. No.: US 2004/0137104 A1
(43) Pub. Date: Jul. 15, 2004

(54) Demolding device for a wax pattern for a golf club head

(75) Inventor: Yuang Ping Lu, Bade City (TW)

Correspondence Address: BACON & THOMAS, PLLC, 625 SLATERS LANE, FOURTH FLOOR, ALEXANDRIA, VA, 22314

(73) Assignee: FU SHENG INDUSTRIAL CO., LTD., Taipei (TW)

(21) Appl. No.: 10/340,631

(22) Filed: Jan. 13, 2003

(51) Int. Cl. B29C 33/44; B29C 45/44

(52) U.S. Cl. 425/438; 425/441; 425/DIG. 58

(57) ABSTRACT

A demolding device includes a support attached to a molding assembly for forming a wax pattern, a rod, a connecting member, and a lever. A first end of the rod is attached to a molding rod for forming the wax pattern. The connecting member has a first end fixed to the support and a second end. The lever has an end pivotally connected to the second end of the rod and the second end of the connecting member. The lever is pivotable between a first position in which the molding rod is moved into the mold assembly and a second position in which the molding rod is moved out of the mold assembly.

### BACKGROUND OF THE INVENTION

1. Field of the Invention

The present invention relates to a demolding device for a wax pattern for a golf club head. In particular, the present invention relates to a demolding device including a lever for pivotally connecting with a rod to which a molding rod is attached, thereby allowing rapid insertion/removal of the molding rod into/from a mold assembly for forming the wax pattern.

2. Description of Related Art

A conventional mold assembly for forming a wax pattern for a golf club head is illustrated in FIG. 1 The mold assembly includes a plurality of outer molds 11, a plurality of mold cores 12, and a supporting member 13. The outer molds 11 are configured to form at least one cavity in the shape of a predetermined golf club head, and the mold cores 12 and the supporting member 13 are received in the cavity. Molten wax is poured into the space between the outer molds 11 and the mold cores 12, and a wax pattern 20 is formed after the wax is cooled and hardened for subsequent manufacture of a golf club head. A molding rod 14 is optionally provided to form a recessed portion 21 in an end of the wax pattern 20 for manufacturing a golf club head with a recessed portion for subsequent welding with a neck.

In order to allow easy insertion and removal of the molding rod 14, a demolding device 30 is provided and includes a support 31 and a rod 32. An inner threading is provided in a through-hole 311 of the support 31 for threading engagement with an outer threading provided on the rod 32. By means of turning the rod 32 to adjust the position of the rod 32 relative to the support 31, the molding rod 14 attached to a side of the support 31 is inserted into the molding assembly (see FIG. 1) for forming the wax pattern 20 or removed from the molding assembly (see FIG. 2) after formation of the wax pattern 20. Although the demolding device 30 is widely used, an operator, however, in case of mass production, has to frequently adjust the position of the rod 32 and to demold after formation of the wax pattern 20, which is time-consuming and thus prolongs the manufacturing procedure for the wax pattern 20.

### OBJECTS OF THE INVENTION

An object of the present invention is to provide a demolding device including a lever for pivotally connecting with a rod to which a molding rod is attached, thereby allowing rapid insertion/removal of the molding rod into/from a mold assembly for forming the wax pattern.

### SUMMARY OF THE INVENTION

To achieve the aforementioned object, the present invention provides a demolding device including a support attached to a molding assembly for forming a wax pattern, a rod, a connecting member, and a lever. A first end of the rod is attached to a molding rod for forming the wax pattern. The connecting member has a first end fixed to the support and a second end. The lever has an end pivotally connected to the second end of the rod and the second end of the connecting member. The lever is pivotable between a first position in which the molding rod is moved into the mold assembly and a second position in which the molding rod is moved out of the mold assembly.

In an embodiment of the invention, the support includes a through-hole. A bolt is extended through the through-hole and has a first end and a second end. A nut is engaged on the first end of the bolt. Further, the bolt includes a longitudinal through-hole through which the rod extends. Two diametrically disposed blind holes are defined in the second end of the bolt for mounting the first end of the connecting member to the bolt.

The end of the lever is substantially Y-shaped and includes two limbs for pivotal connection with the second end of the rod. A lug is formed on each of the limbs for pivotal connection with the second end of the connecting member. The connecting member is substantially H-shaped and includes two side walls and a connecting wall for connecting the side walls. Each side wall has a first end fixed to the second end of the bolt, and each side wall has a second end pivotally connected to the end of the lever.

The demolding device in accordance with the present invention removes the molding rod easily and rapidly through simple and rapid pivotal movement of the lever. The demolding procedure is simplified, and the overall time for manufacturing the wax pattern is reduced.

Other objects, advantages and novel features of this invention will become more apparent from the following detailed description when taken in conjunction with the accompanying drawings.

### BRIEF DESCRIPTION OF THE DRAWINGS

FIG. 1 is a sectional view of a conventional mold assembly for forming a wax pattern for a golf club head.

FIG. 2 is a sectional view similar to FIG. 1, illustrating removal of a molding rod from the conventional mold assembly of FIG. 1.

FIG. 3 is an exploded perspective view of a demolding device in accordance with the present invention.

FIG. 4 is a side view of the demolding device in accordance with the present invention.

FIG. 5 is a side view similar to FIG. 4, wherein a lever of the demolding device is moved to a position for removing a molding rod from the mold assembly.

FIG. 6 is a sectional view of a molding assembly and the molding device in accordance with the present invention, wherein the molding rod is inserted into the mold assembly.

FIG. 7 is a sectional view similar to FIG. 7, wherein the lever of the demolding device is moved to a position for removing the molding rod from the mold assembly.

### DETAILED DESCRIPTION OF THE PREFERRED EMBODIMENT

The present invention is now to be described hereinafter in detail, in which the same referential numerals are used for the same parts as those in the prior art.

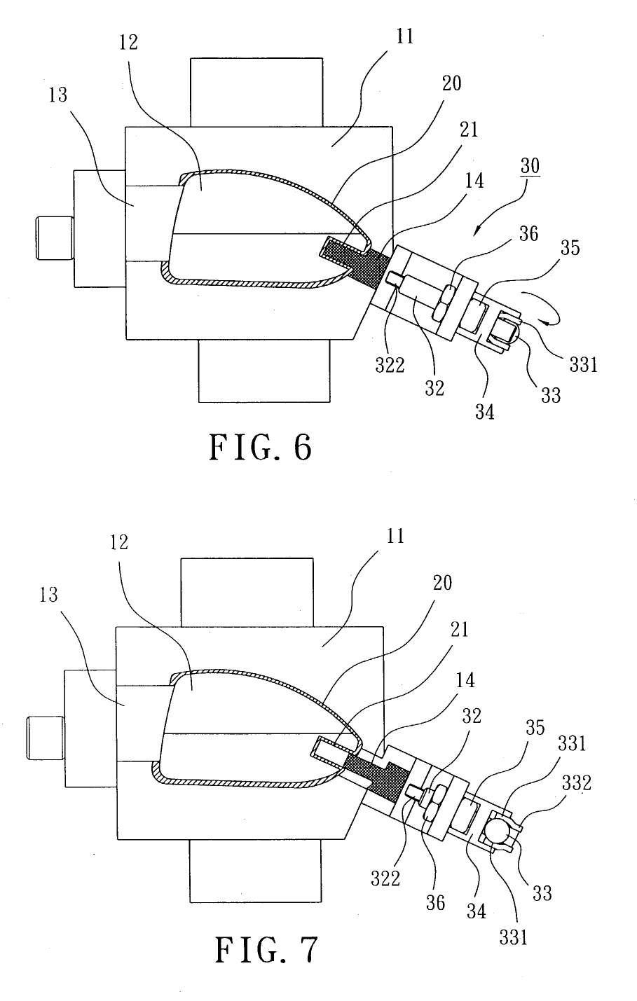

Referring to FIG. 6, a demolding device 30 in accordance with the present invention is provided for a mold assembly for forming a wax pattern 20 for a golf club head (not shown). The mold assembly includes a plurality of outer molds 11, a plurality of mold cores 12, and a supporting member 13 received in the outer molds 13.

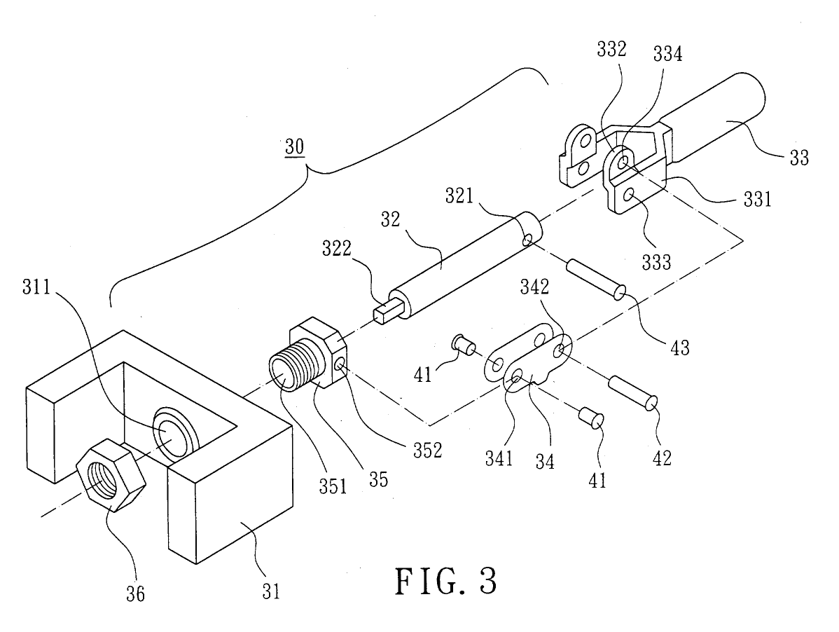

As illustrated in FIGS. 3, 4, and 6, the demolding device 30 in accordance with the preset invention includes a support 31, a lever 33, a connecting member 34, and a rod 32. The support 31 is a substantially U-shaped metal frame that is attached to a predetermined position of one of the outer molds 11 of the mold assembly. The support 31 includes a through-hole 311 defined in a side 310 thereof. A bolt 35 is extended through the through-hole 311. In this embodiment, the bolt 35 has a stem 350 extended through the through-hole 311, with a nut 36 being engaged on the outer threading (not labeled) of the stem 350 and located on an inner side of the support 31. The bolt 35 further has a bolt head 353 located on an outer side of the support 31. The bolt head 353 has two diametrically disposed blind holes 352 defined therein. The bolt 35 further has a longitudinal through-hole 351 extending through the stem 350 and the bolt head 353.

The rod 32 is extended through the longitudinal through-hole 351 of the bolt 35, with a first end 322 of the rod 32 extending beyond the stem 350 and with a second end 320 of the rod 32 extending beyond the bolt head 353. The molding rod 14 is fixed to the first end 322 of the rod 32 to move therewith. A transverse hole 321 is defined in the second end 320 of the rod 32.

The connecting member 34 in this embodiment is a substantially H-shaped member having two side walls 340 connected by a connecting wall 343. Each side wall 340 has a hole 341 in a first end thereof and a hole 342 in a second end thereof. The first ends of the side walls 340 of the connecting member 34 are mounted to the bolt head 353 of the bolt 35, with the hole 341 in each side wall 340 aligned with an associated one of the blind holes 352 of the bolt head 353. A pin 41 is extended through a respective hole 341 and a respective blind hole 352 to thereby fix the first ends of the side walls 340 of the connecting member 34 to the bolt head 350.

The lever 33 includes a first end 330 for grip and a second end 331 to which the second end 320 of the rod 32 and the second ends of the side walls 340 of the connecting member 34 are pivotally attached. In this embodiment, the second end 331 of the lever 33 is substantially Y-shaped and has two limbs 335 each having a pinhole 333. Further, a lug 332 is formed on a distal end of each limb 335 and has a pinhole 334. A pin 43 is extended through the pinholes 334 of the lugs 332 and the transverse hole 321 of the second end 320 of the rod 32. A pin 42 is extended through the pinholes 333 of the limbs 331 of the lever 33 and the holes 342 of the side walls 340 of the connecting member 34.

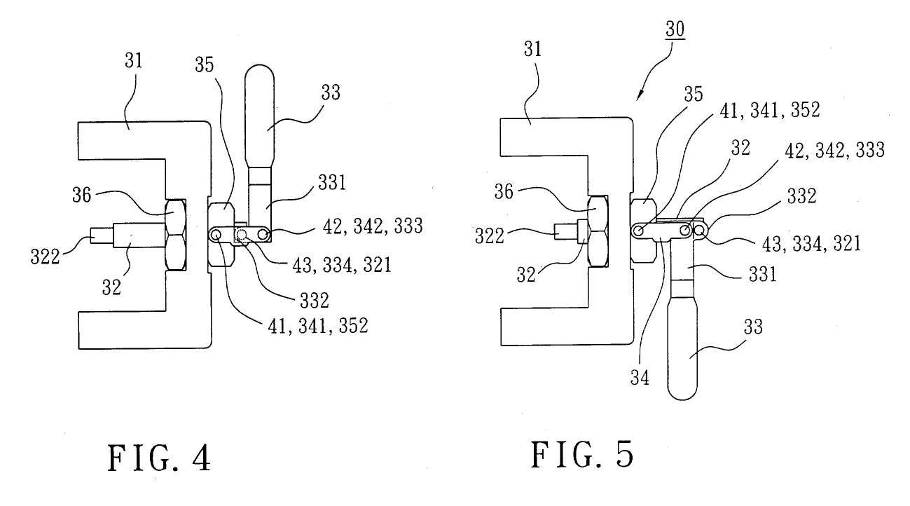

In use, the lever 33 is pivoted to a position shown in FIG. 4, which moves the rod 32 toward the mold assembly. The molding rod 14 is moved to a position shown in FIG. 6 for subsequent formation of the wax pattern 20 in the mold assembly. It is noted that the bolt head 353 of the bolt 35 is pressed against by the lugs 332 of the lever 33 to retain the molding rod 14 in the position shown in FIG. 6. After formation of the wax pattern 20, the lever 33 is pivoted through 180 degrees to a position shown in FIG. 5, which moves the rod 32 away from the mold assembly. The molding rod 14 attached to the rod 32 is removed from the wax pattern 20, as shown in FIG. 7. Thus, a worker may proceed with subsequent demolding procedure for removing the wax pattern 20 out of the mold assembly, and the wax pattern 20 is then placed into another mold (not shown) for manufacturing a golf club head, which is conventional and therefore not described in detail.

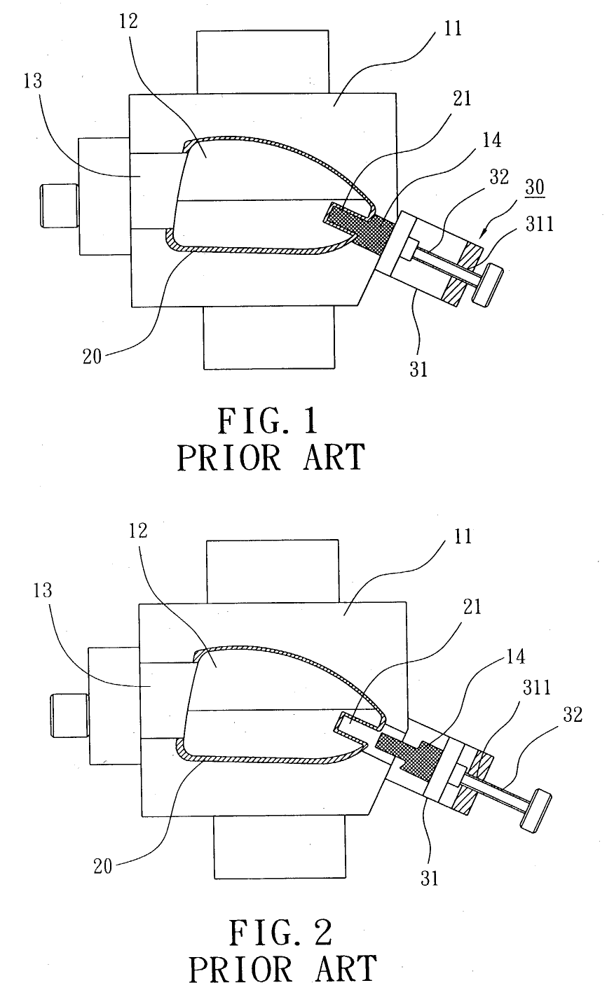

Compare to FIGS. 1 and 2, the demolding device in accordance with the present invention provides a lever 33 for removing the molding rod 14 easily and rapidly through simple and rapid pivotal movement of the lever 33. The demolding procedure is simplified, and the overall time for manufacturing the wax pattern 20 is reduced.

While the principles of this invention have been disclosed in connection with its specific embodiment, it should be understood by those skilled in the art that these descriptions are not intended to limit the scope of the invention, and that any modification and variation without departing the spirit of the invention is intended to be covered by the scope of this invention defined only by the appended claims.

What is claimed is:

1. A demolding device for a molding rod for forming a wax pattern for a golf club head, the demolding device comprising:
a support adapted to be attached to a molding assembly for forming a wax pattern;
a rod having a first end and a second end, the first end of the rod being attached to a molding rod for forming the wax pattern;
a connecting member having a first end fixed to the support and a second end; and
a lever having an end pivotally connected to the second end of the rod and the second end of the connecting member, the lever being pivotable between a first position in which the molding rod is moved into the mold assembly and a second position in which the molding rod is moved out of the mold assembly.

2. The demolding device as claimed in claim 1, wherein the support includes a through-hole, further including a bolt extending through the through-hole and having a first end and a second end, a nut being engaged on the first end of the bolt, the bolt including a longitudinal through-hole through which the rod extends, two diametrically disposed blind holes being defined in the second end of the bolt for mounting the first end of the connecting member to the bolt.

3. The demolding device as claimed in claim 1, wherein the end of the lever is substantially Y-shaped and includes two limbs for pivotal connection with the second end of the rod, further including a lug formed on each of the limbs for pivotal connection with the second end of the connecting member.

4. The demolding device as claimed in claim 2, wherein the connecting member is substantially H-shaped and includes two side walls and a connecting wall for connecting the side walls, each said side wall having a first end fixed to the second end of the bolt, each said side wall having a second end pivotally connected to the end of the lever.

5. The demolding device as claimed in claim 4, wherein the end of the lever is substantially Y-shaped and includes two limbs for pivotal connection with the second end of the rod, further including a lug formed on each of the limbs for pivotal connection with the second end of an associated one of the side walls of the connecting member.
